(19) United States
(12) Patent Application Publication
(10) Pub. No.: US 2015/0193853 A1
(43) Pub. Date: Jul. 9, 2015

(54) Methods and Apparatus to Generate Product Recommendations

(71) Applicants: Leonid Ayzenshtat, Jacksonville, FL (US); Kalyanraman Rajamani, Tampa, FL (US)

(72) Inventors: Leonid Ayzenshtat, Jacksonville, FL (US); Kalyanraman Rajamani, Tampa, FL (US)

(21) Appl. No.: 14/148,266

(22) Filed: Jan. 6, 2014

(51) Int. Cl. G06Q 30/06

(52) U.S. Cl. CPC G06Q 30/0631

(57) ABSTRACT

Methods and apparatus are disclosed to generate product recommendations. A disclosed example method involves generating an affinity rule based on a first set of characteristic values of first products associated with a transaction in response to receiving data identifying the first products associated with the transaction, and generating a product recommendation based on the first set of characteristic values, the product recommendation being indicative of a second product having a second set of characteristic values, the affinity rule identifying a second portion of the second set of characteristic values as having affinity with a first portion of the first set of characteristic values.

### FIELD OF THE DISCLOSURE

This disclosure relates generally to market research, and, more particularly, to methods and apparatus to generate product recommendations.

### BACKGROUND

In recent years, retailers, marketers, and manufacturers have tried to predict which products can be marketed/displayed together to promote sales. These predictions are used, for example, to design promotions, print coupons at the point of sale, design retail floor plans, and/or design products to complement existing products. Market research entities often rely on (a) information generated by loyalty programs, (b) demographics, and/or (c) databases of past transactions to provide product recommendations to consumers, marketers, retailers and manufacturers.

### BRIEF DESCRIPTION OF THE DRAWINGS

FIG. 1 illustrates an example system having one or more transaction processors in communication with a market research entity (MRE) to generate product recommendations.

FIG. 2 illustrates the example characteristic affinity manager of FIG. 1 to receive transaction records and generate product recommendations.

FIG. 3 illustrates an example data structure to associate trade item numbers with product identifiers.

FIG. 4 illustrates an example data structure to associate product identifiers with characteristics values.

FIG. 5 illustrates example transaction sets generated from a transaction record.

FIG. 6 is a flow diagram representative of example machine readable instructions that may be executed to implement an example characteristic affinity manager of FIG. 2 to generate product recommendations.

FIGS. 7 and 8 are flow diagrams representative of example machine readable instructions that may be executed to implement an example product retriever, an example characteristic retriever and/or an example affinity manager of FIG. 2 to generate new transaction sets.

FIG. 9 is a flow diagram representative of example machine readable instructions that may be executed to implement an example affinity generator of FIG. 2 to generate product characteristic affinity rules.

FIG. 10 is a flow diagram representative of example machine readable instructions that may be executed to implement an example affinity generator of FIG. 2 to generate frequent item sets.

FIG. 11 is a flow diagram representative of example machine readable instructions that may be executed to implement the example product recommender of FIG. 2 to generate product recommendations.

FIG. 12 is a block diagram of an example processor system that may execute any of the machine readable instructions represented by FIGS. 6-11 to implement the apparatus of FIGS. 1 and/or 2.

### DETAILED DESCRIPTION

Examples disclosed herein may be used to dynamically generate product recommendations (e.g., coupons, cross-promotional offers, marketing suggestions, product development research, etc.) using affinity rules based on characteristic values. For example, a product recommendation may be generated in response to a transaction being processed by a transaction processor (e.g., a cash register, an online shopping cart, a household-based scanner, credit card processor, etc.). As used herein, “affinity” refers to one or more metrics that predict a likelihood of which products or characteristic (e.g., product characteristics, user characteristics, etc.) values go together in a transaction (e.g., a shopping basket, etc.) with a level of confidence. A high affinity value has a corresponding high level of confidence. A low affinity value has a corresponding low level of confidence. An association is a relationship between a first group of one or more products/characteristic values and a second group of one or more products/characteristic values, where an appearance of the first group in a transaction implies that the second group may also appear in the transaction. An affinity rule is an association that has a greater than a threshold level of support and a greater than a threshold level of confidence.

A market research entity (MRE) may establish a threshold (e.g., minimum) level of support and a corresponding threshold (e.g., minimum) level of confidence to discard insignificant associations and/or to discard one or more associations that occur infrequently. An example MRE may establish a threshold level of confidence of 5%. Further, an example association may state that a “package of cookies implies milk” and may be denoted with an arrow symbol, such as (“a package of cookies”→“milk”). The example association may have a confidence level of 27%. An example affinity rule may state that, with a 27% level of confidence, a package of cookies implies milk (i.e., 27% of the transactions that contain a package of cookies also contain milk).

The MRE may maintain a database of products that associates trade item numbers (e.g., Universal Product Codes (UPC), International Article Numbers (EAN), Japanese Article Numbers (JAN), International Standard Book Numbers (ISBN), Manufacturer Part Numbers (MPN), etc.) with product identifiers (IDs) and/or other product information (e.g., short description, long description, brand, manufacturer, trade item number history, etc.). The product ID may be a unique identifier separate from the trade item number and may be assigned to a product by the MRE. The product IDs may identify products that are part of a transaction or a series of related transactions. Additionally, the MRE may maintain a database of characteristic values to associate product IDs with characteristic values. Characteristic values are a discrete set of uniform descriptors defined by the MRE to categorize products in the products database. Characteristic values include a greater degree of descriptive granularity compared to product information (e.g., short description, long description, etc.) associated with a product in the product database. In some examples, the characteristic values include brand, product type and color, packaging and packaging materials, and marketing claims (e.g. organic, low calorie, etc.), etc. In some examples, a product ID may be associated with a large number of characteristic values. In some examples, the database of products and the database of characteristic values may be linked.

Generating affinity rules using characteristics values allows for generation of targeted product recommendations. Continuing the example discussed above, a package of cookies might be associated with the characteristic values of “high fiber” and “gluten free.” An example affinity rule might state that “high fiber” and “gluten free” characteristic values are related to “skim” with an 80% confidence level. Stated differently, 80% of transactions that include both “high fiber” and “gluten free” characteristic values will also include a “skim” characteristic value. Thus, when a package of high fiber, gluten free cookies appears in a customer's basket, a product recommendation (e.g., a coupon, an advertisement, an instant discount, etc.) to buy skim milk may be generated instead of a generic product recommendation to buy milk. In some examples, when a commercial establishment (e.g., a retailer, a supermarket, a warehouse store, a sports equipment store, etc.) wants to decide which products to stock, example methods and/or apparatus disclosed herein provide strategic information for a product recommendation (e.g., a marketing plan, a layout plan, etc.) by recommending item combinations to stock and/or new products to supplement sales of existing products. For example, a commercial establishment that wants to expand its health food sales may receive a product recommendation to stock both high fiber, gluten free cookies and skim milk. In some examples, a manufacturer that wants to engineer a new product and/or supplement an existing product line may receive a product recommendation (e.g. analysis report, etc.) to create a skim milk latte to supplement strong sales of high fiber, gluten free cookies.

In some examples, a customer may bring products to a transaction processor (e.g., a register, an online shopping cart, a household-based scanner, etc.) At the transaction processor, trade item numbers (e.g., Universal Product Codes (UPC), International Article Numbers (EAN), Japanese Article Numbers (JAN), International Standard Book Numbers (ISBN), Manufacturer Part Numbers (MPN), etc.) associated with the products are scanned (e.g., at a register) and/or retrieved from metadata associated with a product (e.g., at an ecommerce transaction). These products may be grouped to form a new transaction record associated with a transaction identifier (ID). A transaction ID is a value that identifies the transaction record and/or trade item numbers that belong to the transaction record. The new transaction record contains the trade item numbers processed in a transaction (e.g., the trade item numbers associated with the products in a customer's shopping basket at checkout, etc.). In some examples, one or more trade item numbers are sent to the MRE before a transaction is completed (e.g., as the trade item numbers are scanned and/or collected by the transaction processor, etc.). In other examples, the trade item numbers are sent to the MRE as the transaction record when the transaction is complete. As described in further detail below, when the transaction is complete, a new set of affinity rules may be generated using the new transaction and one or more existing transactions from a transaction database. A product recommendation may then be generated. In some examples, the MRE may send the product recommendation to a retailer associated with the transaction. The retailer, in some examples, presents (e.g., via a coupon, via an advertisement, via am instant discount, via a personalized shopping portal, etc.) the product recommendation to the customer associated with the transaction.

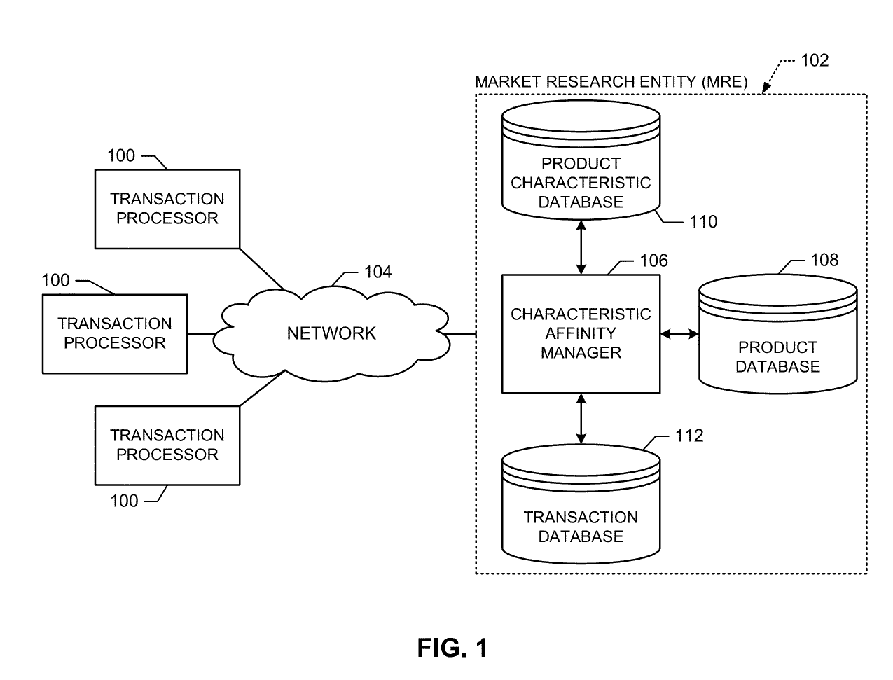

FIG. 1 illustrates example transaction processors 100 (e.g., cash registers, online shopping carts, credit card processors, household-based scanners, etc.) which provide transaction records to an example market research entity (MRE) 102. In some examples, the MRE 102 provides product recommendations (e.g., advertisements, coupons, instant discounts, marketing plans, layout plans, analysis reports, etc.) to the transaction processor 100. In the illustrated example, the example transaction processors 100 communicate with the MRE 102 through a network 104 via a wired and/or wireless connection (e.g., a cable/DSL/satellite modem, a cell tower, etc.).

The MRE of the illustrated example of FIG. 1 includes an example characteristic affinity manager 106, an example product database 108, an example product characteristic database 110, and an example transaction database 112. In the illustrated example of FIG. 1, the MRE 102 is provided with the product database 108 to store product identifiers (IDs) to be used in generating affinity rules. In some examples, the characteristic affinity manager 106 retrieves product IDs from the product database 108 for the products in a new transaction basket. In some examples, the MRE 102 maintains the product database 108 by adding, removing, and/or updating information associated with a product ID (e.g., adding new products, removing obsolete product information, updating product identifiers, etc.).

In the illustrated example of FIG. 1, the MRE 102 is provided with the product characteristics database 110 to store characteristic values to use when generating characteristic value-based affinity rules. In some examples, the product database 108 and the product characteristic database 110 are linked so that retrieving a product ID from the product database 108 also retrieves the characteristic values from the product characteristic database 110 that are associated with the product ID. In some examples, the characteristic affinity manager 106 uses the product ID to retrieve characteristic values associated with the product from the product characteristic database 110. In some examples, the MRE 102 maintains the product characteristic database 110 by adding, removing, and/or updating characteristic values that are associated with product IDs in the product database 108 (e.g., the MRE 102 associates new characteristic values to a product, removes characteristic values associated with a product, etc.). As described above, characteristic values may include brand, product type, color, packaging and packaging materials, and/or marketing claims (e.g. organic, low calorie, etc.), etc. In some examples, the characteristics values are a discrete set of uniform descriptors (e.g., “organic,” “power-saving,” “packaging: silver,” “packaging: red,” etc.) defined by the MRE 102.

The example MRE 102 of FIG. 1 is provided with a transaction database 112 to store transaction baskets used in generating affinity rules. In some examples, when a new transaction record is received from one of the transaction processors 100, the characteristic affinity manager 106 generates a new transaction set (e.g., a set containing characteristic values associated with products in the new transaction record) and stores the new transaction set in the transaction database 112. In some examples, the MRE 102 adds and/or removes transaction sets from the transaction database 112 independent of the characteristic affinity manager 106 to manage the transaction sets used to generate affinity rules (e.g., adds transactions sets from other sources, removes out-of-date transaction sets, etc.).

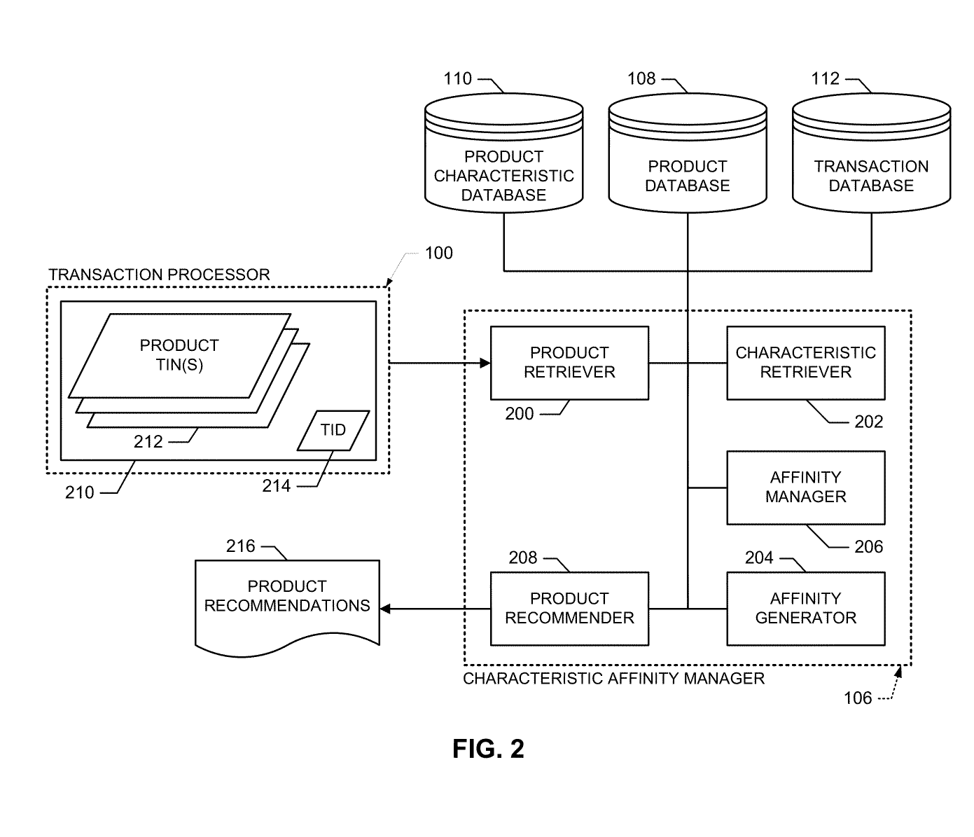

FIG. 2 illustrates an example implementation of the product characteristic generator 106 of FIG. 1. In the illustrated example of FIG. 2, the product characteristic generator 106 includes a product retriever 200, a characteristics retriever 202, an affinity generator 204, an affinity manager 206, and a product recommender 208. The example product retriever 200 receives an example transaction record 210 from a transaction processor (e.g., one of the example transaction processors 100 of FIG. 1) which contains trade item numbers 212 (e.g. Universal Product Codes (UPC), International Article Numbers (EAN), Japanese Article Numbers (JAN), International Standard Book Numbers (ISBN), Manufacturer Part Numbers (MPN), etc.) associated with an example transaction identifier (ID) 214. In some examples, the product retriever 200 receives the trade item numbers 212 associated with the transaction ID 214 from the transaction processor 100 as the trade item numbers 212 are processed by the transaction processor 100 (e.g., as the trade item numbers 212 are being scanned by a point-to-sale device at the transaction processor 100, etc.). In some examples, the transaction processor 100 sends a set of trade item numbers 212 associated with the transaction ID 214 when a transaction is complete (e.g., after a customer checks out/proceeds to check out using an e-commerce retailer, etc.).

In the illustrated example of FIG. 2, upon receiving the trade item numbers 212, the product retriever 200 retrieves product IDs from the product database 108 associated with the received trade item numbers 212. The product IDs may be any value(s) (e.g., alphanumeric value(s), alphanumeric plus symbol value(s), etc.) that uniquely identifies a product in the product database 108. In some examples, the product ID is an alphanumeric value assigned to the product by the MRE 102 (FIG. 1).

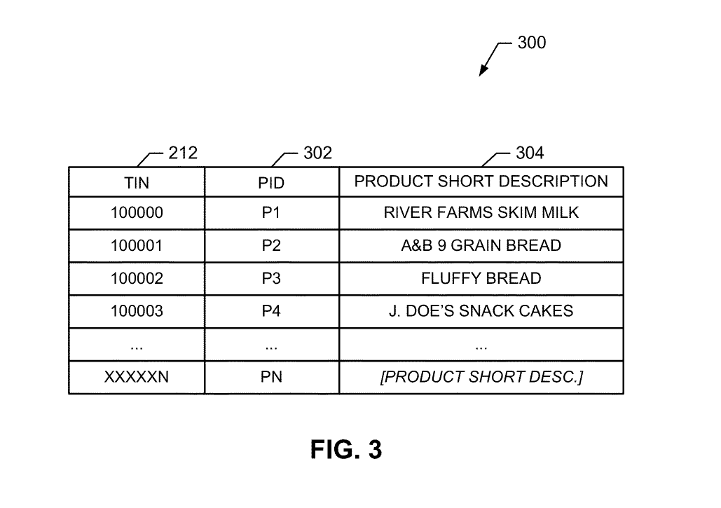

FIG. 3 depicts an example data structure 300 that may be retrieved by the example product retriever 200 (FIG. 2) from the example product database 108. In the illustrated example of FIG. 3, the data structure 300 includes trade item numbers (TIN) (e.g., the trade item numbers 212 of FIG. 2) associated with a product ID (PID) 302 and a product short description 304 (e.g., a description of the product that contains key specifications/features, brand, and/or product name, etc.) A trade item number 212 is a value (e.g., numeric value, alphanumeric value, etc.) associated with a product that uniquely identifies the product. Example implementations of trade item numbers 212 include Universal Product Codes (UPC), International Article Numbers (EAN), Japanese Article Numbers (JAN), International Standard Book Numbers (ISBN), Manufacturer Part Numbers (MPN), etc. In some examples, the trade item number(s) 212 may be associated with other product information (e.g., brand, packaging, trade item number history, long description, etc.) in the product database 108.

In the example illustrated in FIG. 2, the characteristic retriever 202 receives and/or otherwise retrieves the product IDs (e.g., the product IDs 302 of FIG. 3) associated with transaction IDs 214 from the product retriever 200. The example characteristic retriever 202 retrieves characteristic values associated with the example product IDs 302 from the product characteristic database 110.

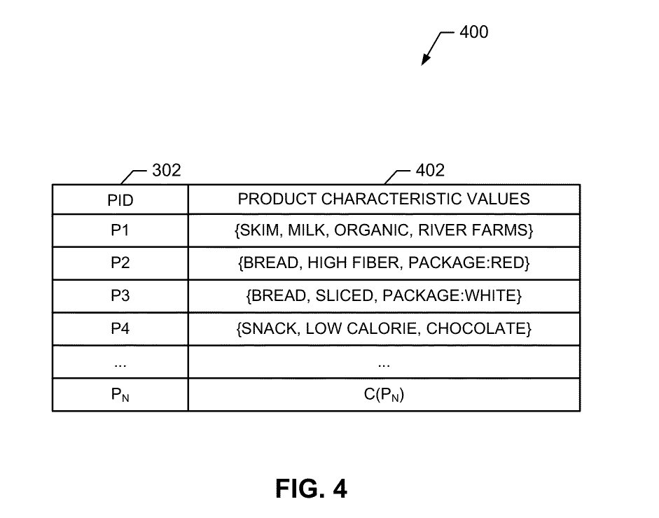

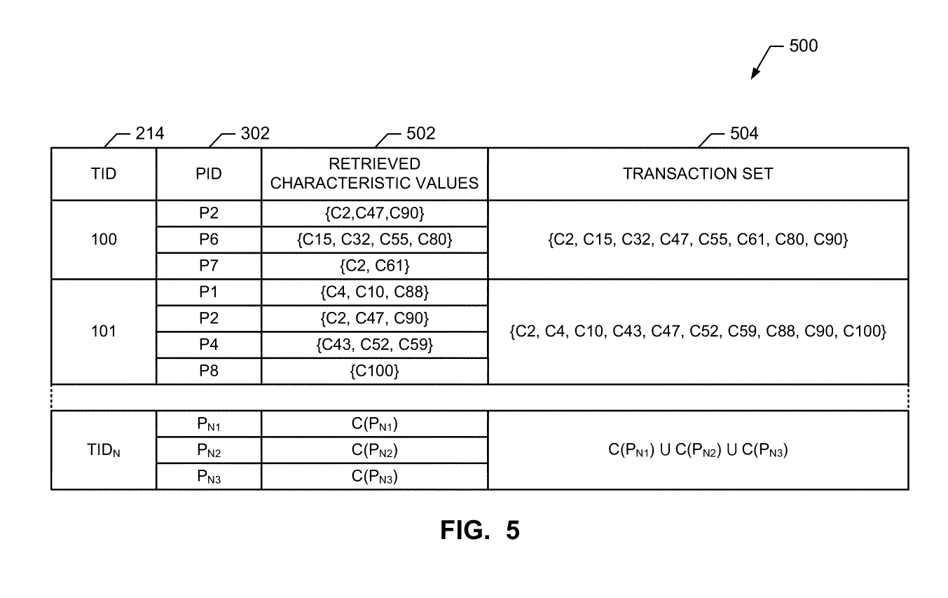

FIG. 4 depicts an example data structure 400 that may be retrieved by the example characteristic retriever 202 from the example product characteristic database 110. In the illustrated example of FIG. 4, product IDs 302 (FIG. 3) are associated with one or more corresponding sets of characteristic values 402. In the illustrated example of FIG. 2, the characteristic retriever 200 creates a transaction set associated with the transaction IDs 214 containing the retrieved sets of characteristic values 402. FIG. 5 depicts example transaction sets 500 created by the example characteristic retriever 202 of FIG. 2 by combining example retrieved characteristic values 502, as described in further detail below.

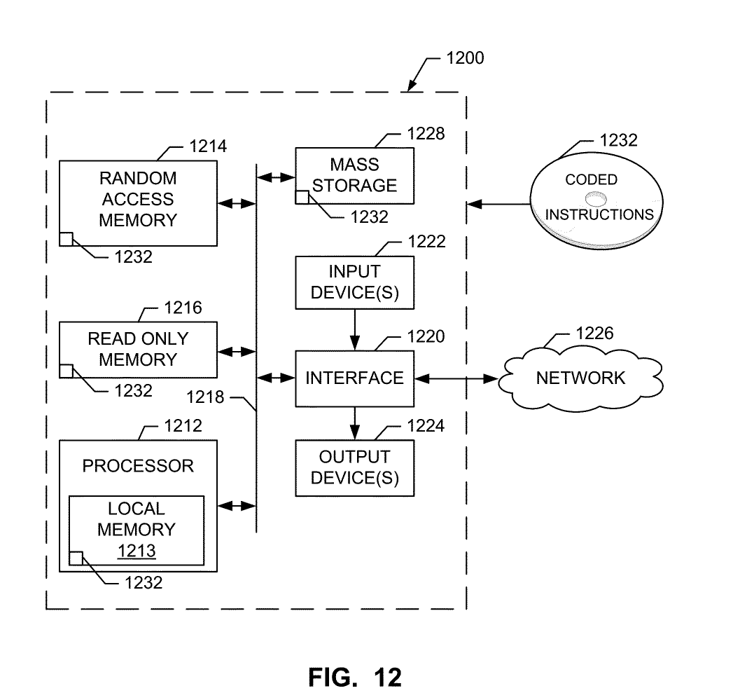

Returning to the illustrated example of FIG. 2, the affinity manager 206 maintains and/or generates a map and/or table of characteristic values. In some examples, the example affinity manager 206 maintains a count on the map and/or table for each of the characteristic values defined by the MRE 102. In some examples, the affinity manager 206 maintains the map and/or table characteristic values in a hash table in memory (e.g. main memory 1214, 1216, and/or mass storage device 1228 of FIG. 12, as described further below). In some examples, the affinity manager 206 iterates through and/or otherwise parses the transaction database 112 and counts the occurrences of characteristic values in one or more transaction sets (e.g., transaction sets 504 of FIG. 5) in the transaction database 112. In the illustrated example of FIG. 2, the affinity manager 206 receives and/or otherwise retrieves the new transaction set from the characteristic retriever 202 and increments the count on the map and/or table of characteristic values corresponding to the characteristic values in the received new transaction set. In some examples, the example affinity manager 206 adds the new transaction set to the transaction database 112 to be used by the example affinity generator 204 as described below.

In the example illustrated in FIG. 2, the affinity generator 204 retrieves transaction sets (e.g., transaction sets 500 of FIG. 5) from the transaction database 112. In some examples, the example affinity generator 204 also receives and/or otherwise retrieves the map and/or table of characteristic value counts from the affinity manager 206. In the illustrated example of FIG. 2, the affinity generator 204 generates item sets from the transaction sets 500. As used herein, an item set is a subset of a transaction set that has at least one element. The example affinity generator 204 then generates frequent item sets from the item sets. As used herein, frequent item sets are item sets that have a threshold (e.g., minimum) level of support. In the illustrated example, support for an item set (e.g. item set X) is defined in a manner consistent with example Equation (1).

$$Sup ( X ) = \frac{No . of Transaction Sets containing X}{Total No . of Transaction Sets} * 100 \% \qquad Equation ( 1 )$$

In some examples, the threshold level of support is a minimum threshold percentage value defined by the MRE 102.

In some examples, the affinity generator 204 generates the frequent item sets by using a frequent item set analysis. The frequent item set analysis may include, for example, a frequent-pattern growth algorithm, an apriori algorithm, a CLOSET algorithm, a CHARM algorithm, an Opus algorithm, and/or any other frequent item set analysis technique. In a frequent-pattern growth algorithm, for example, the affinity generator 204 of the illustrated example constructs a frequent-pattern tree and iterates through conditional trees to generate the item sets from the transaction sets. In such examples, the affinity generator 204 separates item sets that have a threshold (e.g., minimum) level of support (e.g., frequent item sets) and discards the item sets that do not have the threshold (e.g., minimum) level of support. In some examples, before generating frequent item sets, the example affinity generator 204 removes characteristic values from the transaction sets 504 for characteristic values with counts on the map and/or table of characteristic value counts that do not exceed a frequency support threshold defined by the MRE 102.

In the example illustrated in FIG. 2, the affinity generator 204 creates one or more associations from frequent item sets. To generate associations of the frequent item set, the example affinity generator 204 of

FIG. 2 generates nonempty subsets of the frequent item set and creates an association in a manner consistent with example Equation (2).

(S→(F−S)), Equation (2)

where S is a nonempty subset of frequent item set F, S is the left hand side (LHS) of the association, and (F−S) is the right hand side (RHS) of the association. For example, a frequent item set {A, B, C} may have the associations of (A,B→C), (B,C→A), (A,C→B), (C→A,B), (B→A,C), and (A→B,C). The example affinity generator 204 of FIG. 2 calculates a level of confidence for each created association. The level of confidence is defined in a manner consistent with example Equation (3).

$$Conf ( LHS -> RHS ) = \frac{Sup ( LHS ⋃ RHS )}{Sup ( LHS )} * 100 \% \qquad Equation ( 3 )$$

Affinity rules are associations generated from frequent item sets that have a level of confidence about a threshold (e.g., minimum) level of confidence as defined by the MRE 102.

In the example illustrated in FIG. 2, the product recommender 208 receives and/or otherwise retrieves the affinity rule(s) generated by the affinity generator 204. The example product recommender 208 of FIG. 2 also receives and/or otherwise retrieves the new transaction set created by the example characteristic retriever 202 as described above. The example product recommender 208 selects one or more affinity rules that contain characteristic values in the example received new transaction set. The example product recommender 208 of the illustrated example retrieves at least one product ID from the example product characteristic database 110 corresponding to a product with characteristic values that satisfies at least one of the selected affinity rules (e.g., contains characteristic values from the RHS of the affinity rule). In the illustrated example of FIG. 2, the product recommender 208 generates one or more product recommendations 216 (e.g., coupons, advertisement prompts, cross-promotional offers, marketing suggestions, product development research, etc.). In some examples, the product recommender 208 sends the product recommendation 216 to the transaction processor 100 and/or a commercial entity (e.g., a retailer, a marketer, a manufacturer, etc.) associated with the transaction processor 100.

While an example manner of implementing the characteristic affinity manager 106 of FIG. 1 is illustrated in FIG. 2, one or more of the elements, processes and/or devices illustrated in FIG. 2 may be combined, divided, re-arranged, omitted, eliminated and/or implemented in any other way. Further, the example product retriever 200, the example characteristics retriever 202, the example affinity generator 204, the example affinity manager 206, the example product recommender 208 and/or, more generally, the example characteristic affinity manager 106 of FIG. 1 may be implemented by hardware, software, firmware and/or any combination of hardware, software and/or firmware. Thus, for example, any of the example product retriever 200, the example characteristics retriever 202, the example affinity generator 204, the example affinity manager 206, the example product recommender 208 and/or, more generally, the example characteristic affinity manager 106 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, product retriever 200, the example characteristics retriever 202, the example affinity generator 204, the example affinity manager 206, and/or the example product recommender 208 is/are hereby expressly defined to include a tangible computer readable storage device or storage disk such as a memory, a digital versatile disk (DVD), a compact disk (CD), a Blu-ray disk, etc. storing the software and/or firmware. Further still, the example characteristic affinity manager 106 of FIG. 1 may include one or more elements, processes and/or devices in addition to, or instead of, those illustrated in FIG. 2, and/or may include more than one of any or all of the illustrated elements, processes and devices.

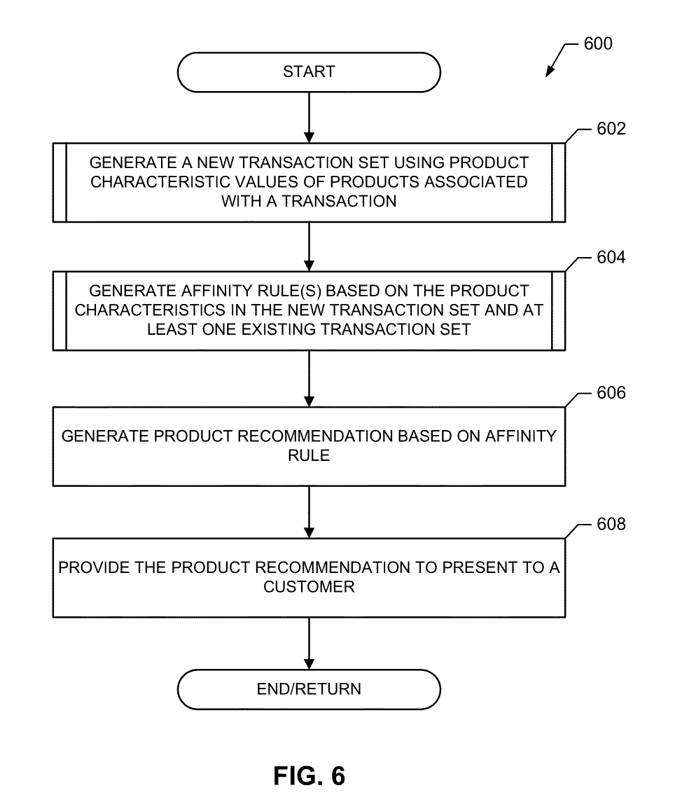

Flowcharts representative of example machine readable instructions for implementing the characteristic affinity manager 106 of FIGS. 1 and 2 are shown in FIGS. 6-11. In these examples, the machine readable instructions comprise a program for execution by a processor such as the processor 1212 shown in the example processor platform 1200 discussed below in connection with FIG. 12. The program may be embodied in software stored on a tangible computer readable storage medium such as a CD-ROM, a floppy disk, a hard drive, a digital versatile disk (DVD), a Blu-ray disk, or a memory associated with the processor 1212, but the entire program and/or parts thereof could alternatively be executed by a device other than the processor 1212 and/or embodied in firmware or dedicated hardware. Further, although the example program is described with reference to the flowcharts illustrated in FIGS. 6-11, many other methods of implementing the example characteristic affinity manager 106 may alternatively be used. For example, the order of execution of the blocks may be changed, and/or some of the blocks described may be changed, eliminated, or combined.

As mentioned above, the example processes of FIGS. 6-11 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 6-11 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

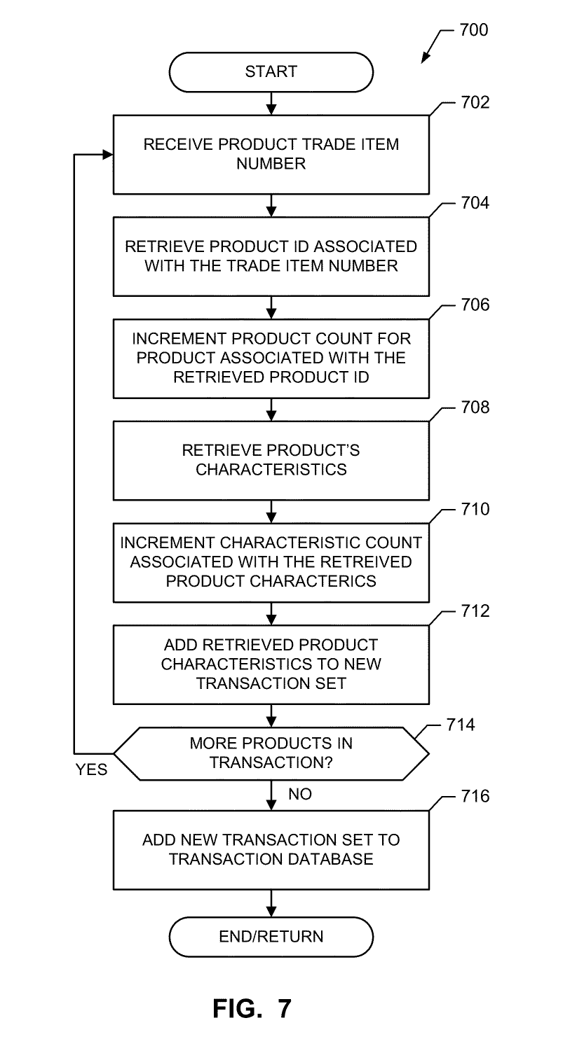

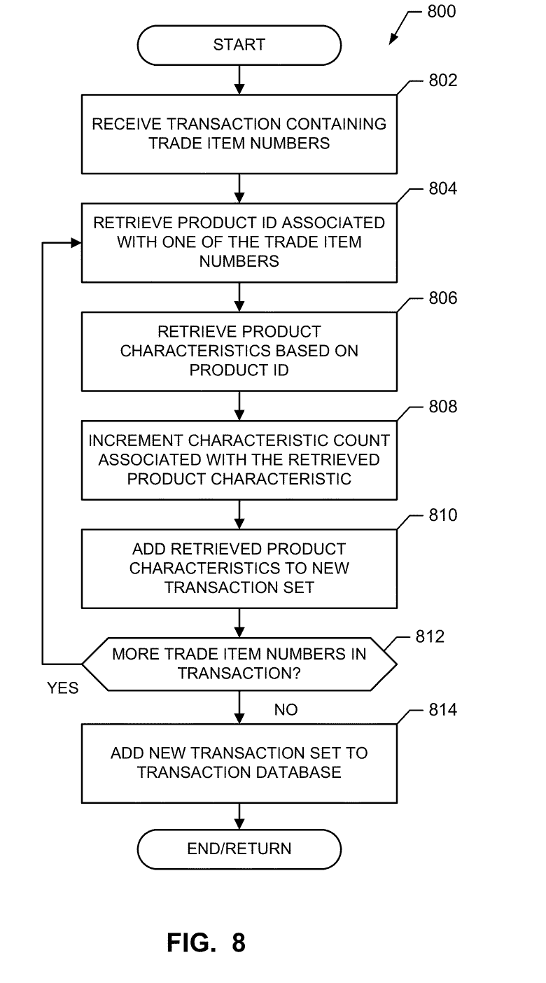

The example program 600 of FIG. 6 is executed to implement the example characteristic affinity manager 106 of FIGS. 1 and 2 to generate one or more product recommendations (e.g., the product recommendation 216 of FIG. 2). Initially, at block 602, the product retriever 200 (FIG. 2), the characteristic retriever 202 (FIG. 2) and/or the affinity manager 206 (FIG. 2) receive and/or otherwise retrieve trade item numbers (e.g., the trade item numbers 212) from a transaction processor (e.g., the one of the transaction processors 100 of FIG. 1), and generate one or more new transaction sets (e.g., one of the transaction sets 504 of FIG. 5) using characteristic values (e.g., the retrieved characteristic values 502 of FIG. 5, the characteristic values 402 of FIG. 4, etc.) retrieved from a product characteristic database 118 (FIG. 1). Example processes that may be used to generate new transaction sets are described below in connection with FIGS. 7 and 8.

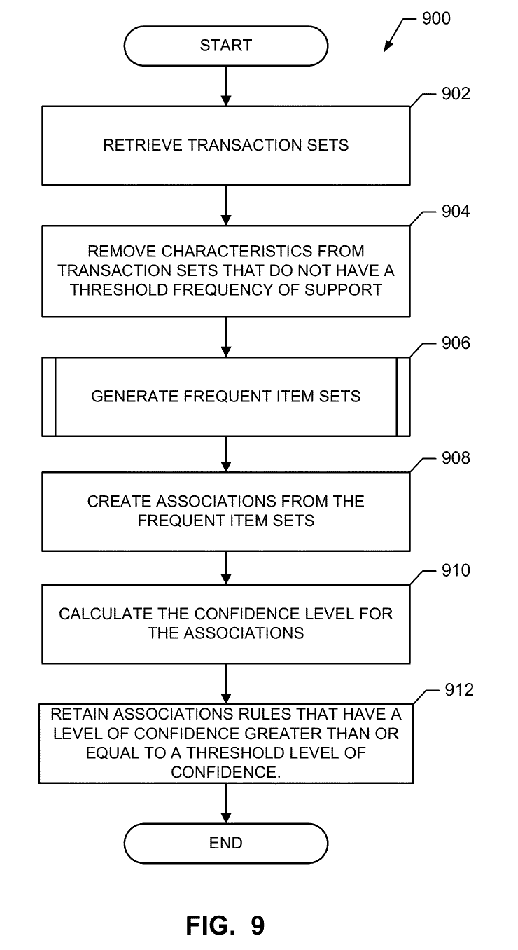

At block 604, the affinity generator 204 (FIG. 2) generates one or more affinity rules based on the new transaction set generated at block 602 and at least one existing transaction set retrieved from the transaction database 112 (FIG. 1). An example process that may be used to generate affinity rules is described below in connection with FIGS. 9. At block 606, the product recommender 208 (FIG. 2) generates a product recommendation (e.g., the product recommendation 216 of FIG. 2) based on the affinity rule(s) generated at block 604. At block 608, the product recommender 208 sends the product recommendation generated at block 606 to the transaction processor 100 that sent the trade item numbers 212 received at block 602. The example program 600 then ends.

An example program 700 of FIG. 7 is executed to implement the example product retriever 200 (FIG. 2), the example characteristic retriever 202 (FIG. 2) and/or the example affinity manager 206 (FIG. 2) to generate new transaction sets (e.g., the transaction sets 500 of FIG. 5). Initially at block 702, the product retriever 200 receives a trade item number (e.g., the trade item number 212 of FIG. 2) associated with a transaction ID (e.g., the transaction ID 214 of FIG. 2). In some examples, the product retriever 200 receives the trade item number from a transaction processor (e.g., transaction processors 100 of FIGS. 1 and 2). At block 704, the product retriever 200 retrieves a product ID (e.g., product ID 302 of FIG. 3) from a product database 108 using the trade item number received at block 702.

At block 706, the affinity manager 206 increments a count on a map and/or table of product counts for the product associated with the product ID retrieved at block 704. At block 708, the characteristic retriever 202 retrieves characteristic value(s) (e.g., the characteristic values 402 of FIG. 4) from the product characteristic database 110 using the product ID retrieved at block 704. At block 710, the affinity manager 206 increments a count on a map and/or table of characteristic counts for characteristic values defined by the MRE 102 (FIG. 1). At block 712, the affinity manager 206 adds the characteristic values retrieved at block 708 to a new transaction set (e.g., one of the transaction sets 500 of FIG. 5) associated with the transaction ID received at block 702.

At block 714, the product retriever 200 determines if there are more products associated with the transaction ID (e.g., has received another trade item number from the transaction processor 100, has not received an end-of-transaction indicator, etc.). If there are more products in the transaction, program control returns to block 702. If there are no more products associated with transaction ID, program control advances to block 716. At block 716, the affinity manager 206 adds the new transaction set generated at block 712 to the transaction database 112. The example program 700 then ends.

An example program 800 of FIG. 8 is executed to implement the example product retriever 200 (FIG. 2), the example characteristic retriever 202 (FIG. 2) and/or the example affinity manager 206 (FIG. 2) to generate new transaction sets (e.g., the transaction sets 500 of FIG. 5). Initially, at block 802, the product retriever 200 receives a transaction record (e.g., the transaction record 210 of FIG. 2) associated with a transaction ID (e.g. the transaction ID 214 of FIG. 2) containing at least one trade item number (e.g., the trade item numbers 212 of FIG. 2). At block 804, the product retriever 200 retrieves a product ID (e.g., product ID 302 of FIG. 3) from a product database 108 using one of the trade item numbers received at block 802.

At block 806, the characteristic retriever 202 retrieves characteristic value(s) (e.g., the characteristic values 402 of FIG. 4) from the product characteristic database 110 using the product ID retrieved at block 804. At block 808, the affinity manager 206 increments a count on a map and/or table of characteristic counts for characteristic values defined by the MRE 102 (FIG. 1). At block 810, the affinity manager 206 adds the characteristic values retrieved at block 806 to a new transaction set (e.g., one of the transaction sets 500 of FIG. 5) associated with the transaction ID received at block 802.

At block 812, the product retriever 200 determines if there are more trade item numbers in the transaction record received at block 802. If there are more products in the transaction, program control returns to block 804. If there are no more trade item numbers in the transaction record, program control advances to block 814. At block 814, the affinity manager 206 adds the new transaction set generated at block 810 to the transaction database 112. The example program 800 then ends.

An example program 900 of FIG. 9 is executed to implement the example affinity generator 204 of FIG. 2 to generate affinity rules based on transaction sets. Initially, at block 902, the affinity generator 204 retrieves transaction sets (e.g., transaction sets 500 of FIG. 5) from the transaction database 112 (FIG. 1) and the new transaction set generated by the affinity manager 206 (FIG. 2). In some examples, the affinity generator 204 retrieves all the transaction sets from the transaction database 112. In some examples, the affinity generator 204 grabs a portion of the transaction sets from the transaction database 112 based on, for example, commercial establishment type (e.g., a grocery store, an electronics store, a warehouse store, etc.), a product category (e.g., electronics, clothing, toys, etc.), a date/range of dates, and/or transaction sets that have characteristic values in common with the new transaction set.

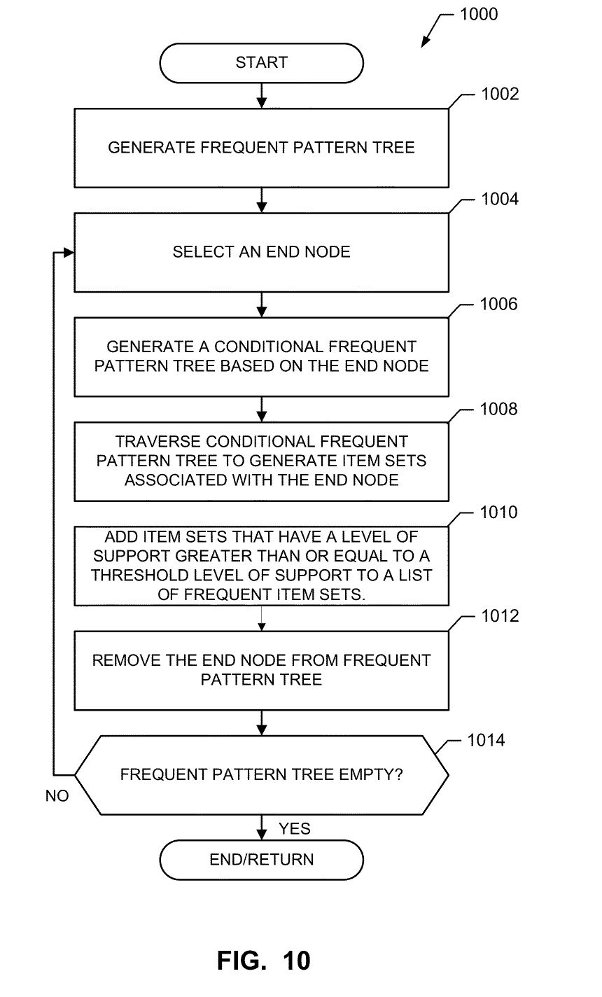

At block 904, the affinity generator 204 removes characteristic values from the transaction sets retrieved at block 902 that do not have counts on the map and/or table of characteristic value counts that are less than a threshold frequency of support defined by the MRE 102 (FIG. 1). At block 906, the affinity generator 204 generates frequent item sets from the transaction sets prepared at block 904. An example process that may be used to generate frequent item sets is described below in connection with FIG. 10. At block 908, the affinity generator 204 creates associations from the frequent item sets generated at block 906. At block 910, the affinity generator 204 calculates a level of confidence (e.g., using Equation (3) discussed above) for each of the associations created at block 908. At block 912, the affinity generator 204 compares the levels of confidence for the association rules calculated at block 910 to a threshold level of confidence defined by the MRE 102. The affinity generator 204 retains, as affinity rules, the association with a level of confidence that is greater than or equal to the threshold level of confidence. The example program 900 then ends.

An example program 1000 of FIG. 10 is executed to implement the example affinity generator 204 of FIG. 2 to generate frequent item sets based on transaction sets. Initially, at block 1002, the affinity generator 204 generates a frequent-pattern tree from transaction sets (e.g. the transaction sets 500 of FIG. 5). In some examples, the example affinity generator 204 generates a frequent pattern-tree using at least a portion of transaction sets retrieved from a transaction database 112 (FIG. 1) (e.g., the transaction sets retrieved at block 902 by example program 900 of FIG. 9). At block 1004, the affinity generator 204 selects an end node on the frequent-pattern tree generated at block 1002. At block 1006, the affinity generator 204 generates a conditional frequent-pattern tree based on the end node selected at block 1004.

At block 1008, the affinity generator 204 traverses the conditional frequent-pattern tree generated at block 1006 to create item sets associated with the end node selected at block 1004. At block 1010, the affinity generator 204 calculates a level of support (e.g., using Equation (1) discussed above) for the item sets created at block 1008 and adds the item sets generated at block 1008 that have a level of support greater than or equal to a threshold level of support as defined by the MRE 102 (FIG. 1) to a list of frequent item sets. At block 1012, the affinity generator 204 removes the end node selected at block 1004 from the frequent-pattern tree generated at block 1002. At block 1014, the affinity generator 204 determines whether the frequent-pattern tree is empty. If the frequent-pattern tree is not empty, program control returns to block 1004. If the frequent-pattern tree is empty, the example program 1000 ends.

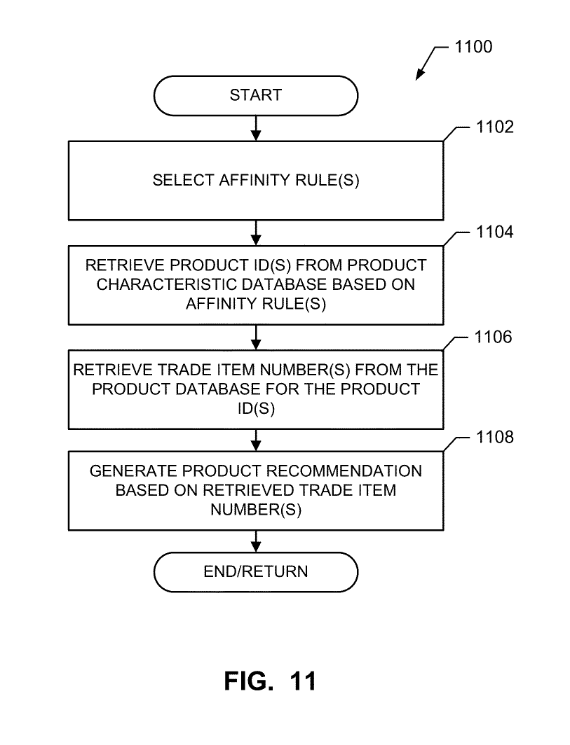

An example program 1100 of FIG. 11 is executed to implement the example product recommender 208 of FIG. 2 to generate product recommendations (e.g., the product recommendation 216 of FIG. 2). Initially, at block 1102, the product recommender 208 selects one or more affinity rules (e.g., the affinity rules generated by example program 900 of FIG. 9). In some examples, the product recommender 208 selects an affinity rule containing characteristic values on the LHS of the affinity rule that are in the transaction set created by the characteristic retriever 202 (FIG. 2). At block 1104, the product recommender 208 retrieves one or more product IDs from the product characteristic database 110 (FIG. 1) that are associated with characteristic values on the RSH of the affinity rule selected at block 1102. At block 1106, the product recommender 208 retrieves trade item numbers associated with the product IDs retrieved at block 1102 from the product database 108 (FIG. 1). At block 1108, the product recommender 208 generates a product recommendation (e.g., coupons, advertisement prompts, cross-promotional offers, marketing suggestions, product development research, etc.) based on the trade item numbers retrieved at block 1104. The example program 1100 then ends.

FIG. 12 is a block diagram of an example processor platform 1000 capable of executing the instructions of FIGS. 6-11 to implement the characteristic affinity manager 106 of FIGS. 1 and 2. The processor platform 1200 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1220 of the illustrated example, thus, typically includes a graphics driver card, a graphics driver chip or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.).

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID systems, and digital versatile disk (DVD) drives.

The coded instructions 1232 of FIGS. 6-11 may be stored in the mass storage device 1228, in the volatile memory 1214, in the non-volatile memory 1216, and/or on a removable tangible computer readable storage medium such as a CD or DVD.

From the foregoing, it will be appreciated that examples have been disclosed which allow affinity rules for characteristic values to be dynamically generated with up-to-date transaction sets. Additionally, examples have been disclosed which allow a market research entity to provide cross promotional planning through characteristic value level affinity rules.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method comprising:
generating an affinity rule based on a first set of characteristic values of first products associated with a first transaction in response to receiving data identifying the first products associated with the first transaction; and
generating a product recommendation based on the first set of characteristic values, the product recommendation being indicative of a second product having a second set of characteristic values associated with a second transaction, the affinity rule identifying a second portion of the second set of characteristic values as having affinity with a first portion of the first set of characteristic values.

2. A method as defined in claim 1, further including providing the product recommendation for presentation to a consumer associated with the first transaction.

3. A method as defined in claim 1, wherein characteristic values below a threshold frequency of support are removed from the first set of characteristic values.

4. A method as defined in claim 3, wherein the threshold frequency of support is set to remove characteristic values that do not have enough support to be used to generate the affinity rule.

5. A method as defined in claim 1, further including retrieving a third set of characteristic values from a transaction database, wherein the affinity rule is based on the first set of characteristic values and the third set of characteristic values.

6. A method as defined in claim 5, wherein characteristic values are removed from the first set of characteristic values and the third set of characteristic values that are below a threshold frequency of support.

7. A method as defined in claim 5, wherein the third set of characteristic values and the first set of characteristic values have a same characteristic value.

8. A method as defined in claim 1, further including generating the first set of characteristic values based on a transaction record containing trade item identifiers associated with the products in the first transaction.

9. A method as define in claim 1, wherein the affinity rule is generated using at least one of a frequent-pattern growth algorithm, an apriori algorithm, a CLOSET algorithm, a CHARM algorithm, or an Opus algorithm.

10. A tangible computer readable storage medium comprising instructions which, when executed, cause a machine to at least:
after receiving data identifying a first product in a first transaction, generate an affinity rule based on the first set of characteristic values associated with the first transaction and a second set of characteristic values associated with a second transaction; and
generate a product recommendation based on the affinity rule, the product having a third set of characteristic values, wherein the affinity rule identifies a portion of the third set of characteristic values that have affinity with a portion of the first set of characteristic values.

11. A tangible computer readable storage medium as defined in claim 10, wherein the instructions further cause the machine to at least:
provide the product recommendation for presentation to a customer associated with the first transaction.

12. A tangible computer readable storage medium as defined in claim 10, wherein the instructions further cause the machine to at least:
remove characteristic values from the first set of characteristic values and the second set of characteristic values that are below a threshold on a table of counts of characteristic values.

13. A tangible computer readable storage medium as defined in claim 10, the instructions further cause the machine to at least:
select the second set of characteristic values from a plurality of sets of characteristic values so that a first characteristic value in the second set of characteristic values is equal to a second characteristic value in the first set of characteristic values.

14. A tangible computer readable storage medium as defined in claim 10, wherein the instructions further cause the machine to at least:
generate the first set of characteristic values based on trade item numbers associated with the first transaction.

15. An apparatus comprising:
a product retriever to retrieve product identifiers corresponding to trade item numbers associated with a first transaction record received from a transaction processor;
a characteristic value retriever to retrieve characteristic values corresponding to the product identifiers retrieved by the product retriever and to create a first transaction set associated with the first transaction;
an affinity generator to generate an affinity rule based on the first transaction set and a second transaction set; and
a product recommender to generate a product recommendation based on the affinity rule generated by the affinity generator.

16. The apparatus of claim 15, further including an affinity manager to track characteristic values and to remove characteristic values that are below a threshold frequency of support from the first transaction set and the second transaction set before the affinity generator generates the affinity rule.

17. The apparatus of claim 16, wherein the affinity manager is to add the first transaction to a database of transaction sets.

18. The apparatus of claim 15, wherein the product recommender is to provide the product recommendation to the transaction processor to be presented to a customer associated with the first transaction.

19. The apparatus of claim 15, wherein the product retriever is to receive the trade item numbers associated with the first transaction as the trade item numbers are being processed by the transaction processor.

20. The apparatus of claim 15, wherein the affinity generator is to generate the affinity rule using at least one of a frequent-pattern growth algorithm, an apriori algorithm, a CLOSET algorithm, a CHARM algorithm, or an Opus algorithm.
